(19) United States
(12) Patent Application Publication
(10) Pub. No.: US 2009/0120017 A1
(43) Pub. Date: May 14, 2009

(54) HOLDING DEVICE FOR SASH MEMBER

(75) Inventors: Hiroki Baba, Hagagun, Tochigi (JP); Hideki Mayama, Hagagun, Tochigi (JP); Shigetoshi Namiki, Hagagun, Tochigi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/813,260

(22) PCT Filed: Dec. 7, 2005
(86) PCT No.: PCT/JP05/22903

§ 371 Date: Jul. 11, 2007

(30) Foreign Application Priority Data
Jan. 7, 2005 (JP) 2005-002384
Jan. 7, 2005 (JP) 2005-002448

(51) Int. Cl. E06B 3/988

(52) U.S. Cl. 52/204.71

(57) ABSTRACT

A holding device for a sash member (11) formed in a recessed shape in cross section. The device comprises rotating pressing members (47, 47) having overall lengths (L) longer than a distance (D) between the inner faces of both side walls (11a, 11b) of the sash member. The rotating pressing members are rotated by drive sources (44, 101) to press the inner faces of both side walls of the sash member by their both ends so as to rapidly hold the sash member. Also, the device comprises a sash positioning member (117) for positioning the sash member relative to the other sash member (16).

### TECHNICAL FIELD

The present invention relates to a holding device for a sash member and, more particularly, to a device for holding and positioning a lower sash upon attachment of the lower sash to an upper sash.

### BACKGROUND ART

Sash members for guiding door glass in vehicle doors are known in the art. These sash members guide a front edge and a rear edge of the door glass (for example, JP 05-69865 A). A description of such a vehicle door shall be provided with reference to FIG. 13 hereof.

A conventional vehicle door 200, as shown in FIG. 13, is composed of an outer panel part 201, and an inner panel part 202 mounted to a vehicle interior side of the outer panel part 201.

The outer panel part 201 comprises a door outer panel 204 constituting a lower part, and a door frame 205 mounted to an upper part of the door outer panel 204. A cut-out 206 for inserting the inner panel part 202 is formed on the door outer panel 204.

The inner panel 202 comprises a door inner panel 207, wherein a door glass 212 and a door glass guide 214 for guiding a front edge of the door glass 212 is attached to the door inner panel part 207.

The door glass 212 comprises a corner piece 216 on a rear edge. The corner piece 216 fits into a door glass run in the door frame 205 in a state in which the inner panel part 202 is mounted to the outer panel part 201, whereby the door glass 212 is guided while being raised or lowered.

An upper part of the rear edge of the door glass 212 is guided by the door frame 205 via the corner piece 216. However, a lower part of the rear edge of the door glass 212 is not guided. Therefore, the lower part of the rear edge of the door glass 212 vibrates, e.g., in a direction perpendicular to the page space, thereby hindering the raising and lowering of the door glass 212, or generating an abnormal noise.

Therefore, a configuration has been considered in which, e.g., a lower sash 220 (indicated by the imaginary line) is provided below the rear part of the door frame 205 in order to securely guide the lower part of the door glass 212.

When the lower sash 220 is mounted to the door outer panel 204 using a robot or other tool, concerns related to cost and productivity require the device for gripping the lower sash 220 using the robot to be uncomplicatedly structured, highly versatile, and capable of gripping the sash rapidly and stably.

As is also the case when the lower sash 220 is mounted to the door outer panel 204 using a robot or other tool, the lower sash 220 must be positioned so as to form a connection with a lower end of the door frame 205 while accommodating any error resulting from the installation of the door frame 205 so that the door glass 212 will be smoothly guided. Concerns related to cost and productivity require the positioning device to be uncomplicatedly structured, and capable of performing positioning in a straightforward manner.

### DISCLOSURE OF THE INVENTION

According to an aspect of the present invention, there is provided a holding device for holding a sash member of U-shaped cross section with a groove, the holding device comprising: rotating pressing means having an overall length longer than a width of the groove and being designed to be rotated by a drive source to press against inner surfaces of both side walls of the sash member upon rotation thereof; and a sash positioning member which is positioned in the groove upon pressing of the rotation pressing means against the inner surfaces of the side walls, and which comes into contact with at least one of the side walls for positioning the sash member relative to a companion sash member.

The holding device for a sash member is an uncomplicated device composed of the rotating pressing means, which can be made to rotate by the drive source, and the sash positioning member, which can make contact with the inner surface of at least one of the side walls of the sash member. The rotating pressing means is made to rotate by the drive source and presses against the inner surface of the side wall of the sash member, therefore enabling the hold to be maintained even in sash members in which the distance between the side walls is different. The sash member can be rapidly held merely by the rotation of the rotating pressing means. The sash member is supported by the sash positioning member in addition to the rotating pressing means. Therefore, the sash member is stably held.

Even with sash members having recessed shapes in cross section and different distances between the side walls thereof, the rotating pressing means can maintain a hold corresponding to the distance between the side walls of the sash member being held. The holding device for a sash member will be highly versatile, and a holding device need not be prepared for each sash member having a different distance.

The uncomplicated and versatile structure is thus able to reduce the cost of the holding device for a sash member.

The sash member can be rapidly gripped merely by the rotating pressing means being rotated by the drive source, and productivity can be improved when the vehicle door is manufactured. In addition, the sash positioning member that can make contact with an inner surface of at least one side wall of another sash member is provided. Therefore, the sash member that is held can further be supported by the positioning member, and the sash member can be stably held.

Preferably, the rotating pressing means has inclined parts provided on longitudinally opposite ends thereof for contact with the inner surfaces of the side walls of the sash member. The contacting surface area of the inner surfaces of the side walls of the sash member is increased by the inclined parts. The sash member can therefore be held in a stable state.

According to another aspect of the present invention, there is provided a holding/positioning device for holding and positioning, relative to a first sash member mounted to an associated member, a second sash member in a held state, the holding/positioning device comprising: a platform for mounting to conveying means; first holding means mounted to the platform for holding the second sash member; a floating mechanism mounted to an intermediate part of the first holding means in such a manner as to be capable of floating and returning to an original position thereof; second holding means mounted to the floating mechanism for holding the second sash member; and fitting/positioning means provided to the floating mechanism in such a manner as to be insertable into a connecting part provided to the first sash member, so that an end of the second sash member held by the first and second holding means is positioned relative to a corresponding end of the first sash member.

The fitting/positioning member is inserted into the connecting part of the first sash member and the end part of the second sash is positioned in a state in which the second sash member held by the first holding means and the second holding means is made to float using the floating mechanism with the intermediate part of the first holding means acting as a fulcrum. Thus, the second sash member gripped by the first holding means and second holding means can be made to float using an uncomplicated structure, and the second sash member is made to float using the floating mechanism, whereby the second sash member is readily positioned relative to the first member by the fitting/positioning member while any error associated with contact against the intended mounting member of the first sash member is eliminated.

### BRIEF DESCRIPTION OF THE DRAWINGS

FIG. 1 is a side view of a device for holding and positioning a sash member, according to the present invention, and a vehicle door;

FIG. 2 is a side view of the positioning device shown in FIG. 1

FIG. 3 is an enlarged scale cross-sectional view of the positioning device shown in FIG. 2;

FIG. 4 is an enlarged view as seen from the direction of arrow 4 of FIG. 2;

FIGS. 5A and 5B are partial cross-sectional views of the holding device according to the present invention;

FIG. 6 is an enlarged scale cross-sectional view of a fitting/positioning member shown in FIG. 2;

FIG. 7 is a view as seen in the direction of arrow 7 of FIG. 6;

FIG. 8 is a view as seen in the direction of arrow 8 of FIG. 2;

FIGS. 9A and 9B are schematic views showing operations of a first floating mechanism and a first lock mechanism shown in FIG. 3;

FIGS. 10A and 10B are schematic views showing operations of a second floating mechanism and a second lock mechanism shown in FIG. 3;

FIGS. 11A through 11C are schematic views showing a state in which a lower sash is held by a holding piece;

FIGS. 12A through 12D are schematic views showing a procedure for positioning the lower sash relative to an upper sash; and

FIG. 13 is a side view showing a state in which a conventional vehicle door is in the process of being assembled.

### BEST MODE FOR CARRYING OUT THE INVENTION

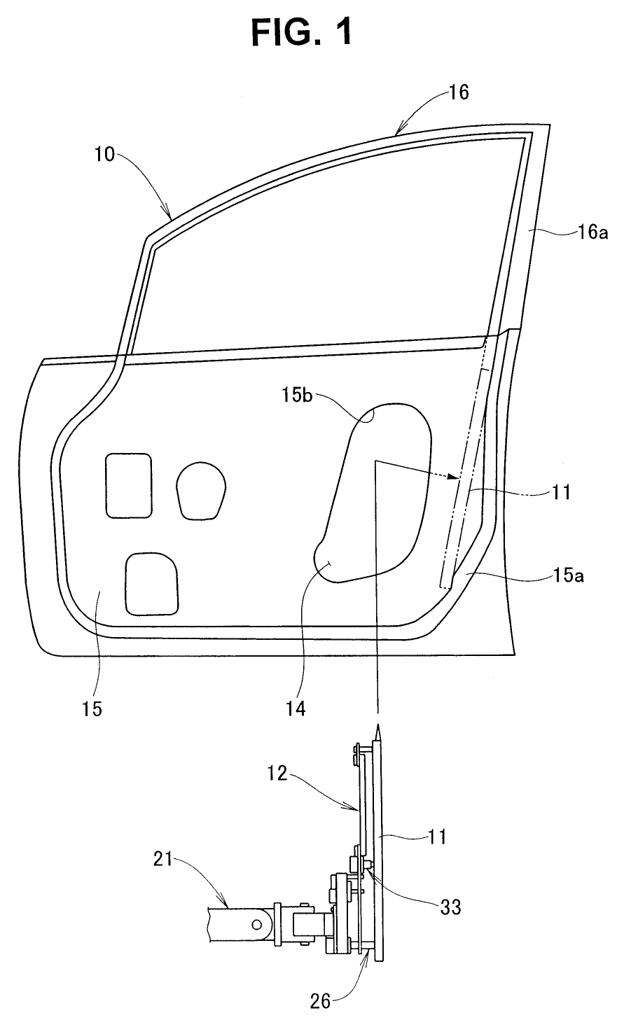

FIG. 1 shows a state in which a lower sash 11 is mounted to an inside of a vehicle door 10 by a holding and positioning device 12 for a sash member (referred to below simply as “positioning device 12”).

The positioning device 12 comprises a first holding device 26 and a second holding device 33 for holding the lower sash 11.

The vehicle door 10 comprises an outer panel 14, an inner panel 15 mounted to a vehicle interior side of the outer panel 14, and an upper sash 16 mounted to an upper part of the outer panel 14 and the inner panel 15.

The lower sash 11 is disposed between the outer panel 14 and the inner panel 15 so as to be connected as an extension of a rear edge part 16a of the upper sash 16 in order to guide the rear edge of the door glass (not shown) while the door glass is raised or lowered. An upper end of the lower sash is connected to the rear edge 16a, and a lower end is mounted to a rear wall 15a of the inner panel 15.

The positioning device 12 is mounted to a distal end of a conveying device 21. The positioning device 12 that grips the lower sash 11 is inserted into the interior by the conveying device 21 from an open part 15b formed on the inner panel 15 as indicated by the arrow, and the lower sash 11 is positioned relative to the rear edge part 16a of the upper sash 16 by the positioning device 12. Once the lower sash 11 has been positioned, the lower sash 11 is anchored to the inner panel 15 by a bolt.

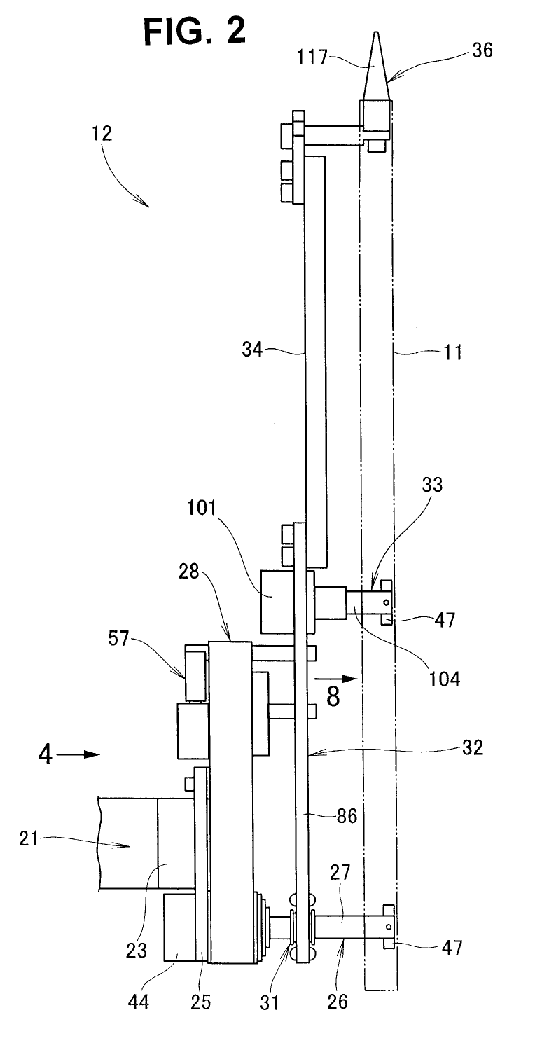

The positioning device 12 shown in FIG. 2 is composed of a platform 25 mounted to the conveying device 21 via a force sensor 23; the first holding device 26 mounted to an end part of the platform 25 in order to hold the lower sash 11; a first floating mechanism 28 swingably mounted to a rotation shaft 27 provided to the first holding device 26; a second floating mechanism 32 mounted to the rotation shaft 27 so as to be able to be moved by a spherical sliding bearing 31; the second holding device 33 mounted to an end part of the second floating mechanism 32 in order to hold the lower sash 11; an extending member 34 that extends from the second floating mechanism 32 in the vicinity of the second holding device 33; and a fitting/positioning member 36 mounted to a distal end part of the extending member 34.

The force sensor 23 detects forces in axial directions of three mutually perpendicular axes, as well as torque about the axes. The operation of the conveying device 21 is controlled by a control device (not shown) on the basis of the forces in the axial directions and the torque about the axes detected by the force sensor 23, and the orientation of the positioning device 12 is controlled.

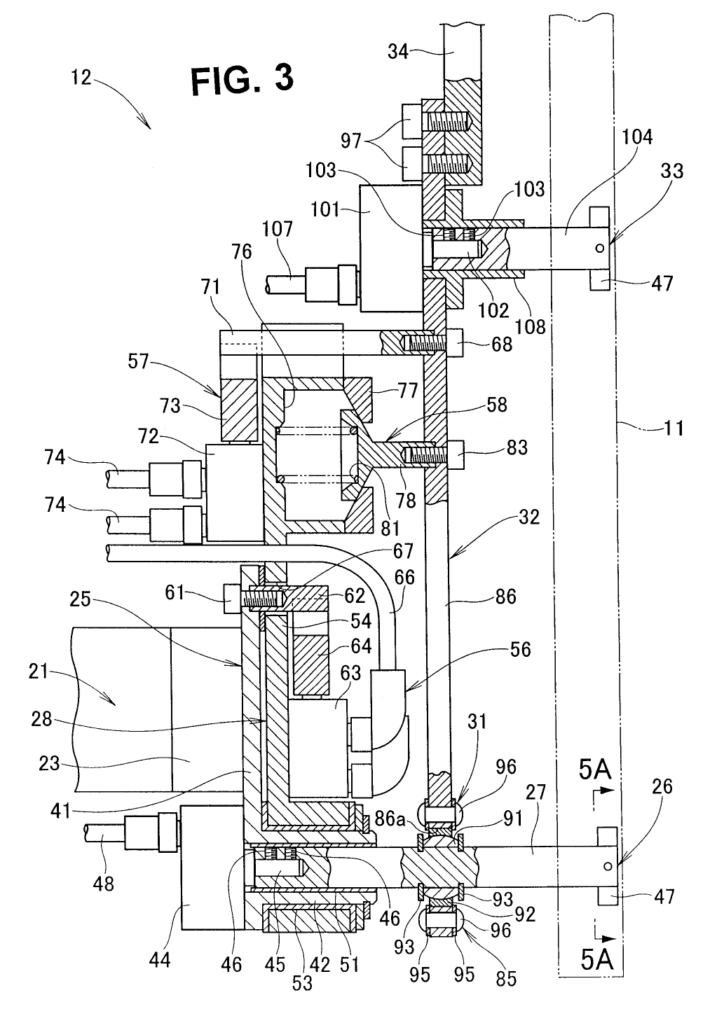

The platform 25 of the positioning device 12 is composed of a flat base part 41 and a tubular part 42 formed integrally with the base part 41, as shown in FIG. 3.

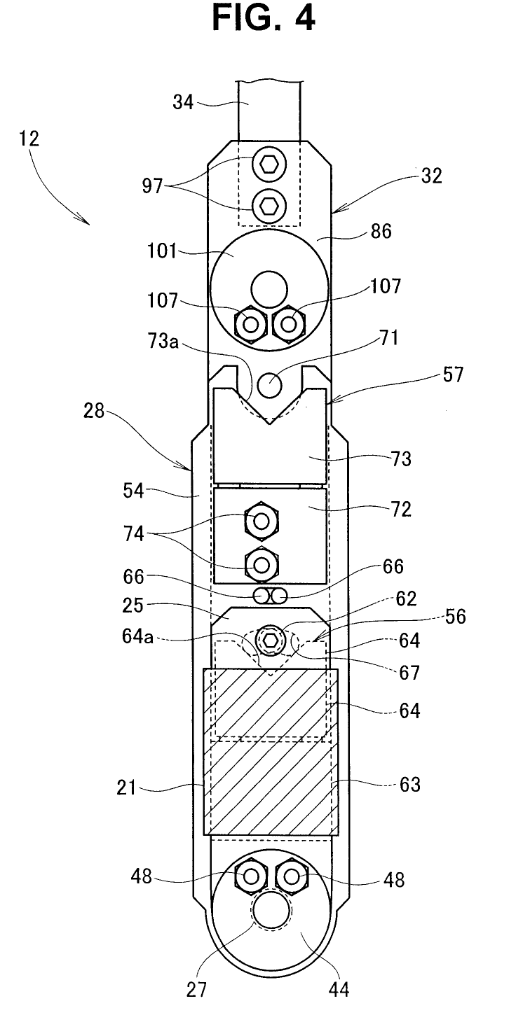

The first holding device 26 is composed of a hydraulic motor 44 mounted to the base part 41 of the platform 25; the rotation shaft 27 mounted to an output shaft 45 of the hydraulic motor 44 by stopper screws 46, 46; a holding piece 47 mounted to a distal end of the rotation shaft 27; and hydraulic pipes 48, 48 (see FIG. 4) connected to the hydraulic motor 44. The rotation shaft 27 is held on the tubular part 42 of the platform 25 via bushing 51.

The first floating mechanism 28 is composed of a main body part 54 swingably mounted to the tubular part 42 of the platform 25 via bushing 53; and a first lock mechanism 56, a second lock mechanism 57, and a centering mechanism 58 that are mounted to the main body part 54.

The first lock mechanism 56 locks the floating (swinging) of the mechanism 28 relative to the platform 25; and is composed of a first lock pin 62 mounted to the platform 25 by a bolt 61, a first cylinder part 63 mounted to the main body part 54, a first lock member 64 that is driven by the first cylinder part 63 and that engages with the first lock pin 62, and hydraulic tubes 66, 66 (see FIG. 4) that supply hydraulic pressure to the first cylinder part 63. The reference symbol 67 indicates an arched elongated hole formed on the main body part 54, and is a portion that allows the main body part 54 to swing relative to the first lock pin 62.

The second lock mechanism 57 locks the floating of the second floating mechanism 32 relative to the first floating mechanism 28; and is composed of a second lock pin 71 mounted to the second floating mechanism 32 by a bolt 68, a second cylinder part 72 mounted to the main body part 54 of the first floating mechanism 28, a second lock member 73 that is driven by the second cylinder part 72 and engages with the second lock pin 71, and hydraulic pipes 74, 74 that supply hydraulic pressure to the second cylinder part 72.

The centering mechanism 58 centers the second floating mechanism 32 relative to the first floating mechanism 28 and is composed of a recessed part 76 provided to the main body part 54, a tapered member 77 mounted to an open part of the recessed part 76, a centering piece 78 mounted to the second floating mechanism 32 and having a tapered face that is in contact with the tapered member 77, and a spring 81 interposed between the centering piece 78 and a bottom of the recessed part 76 in order to press the centering piece 78 against the tapered member 77. The reference symbol 83 indicates a bolt for mounting the centering piece 78 to the second floating mechanism 32.

The second floating mechanism 32 is composed of the spherical sliding bearing 31 mounted to the rotation shaft 27, and a main body part 86 mounted to the spherical sliding bearing 31 via a stopper mechanism 85.

The spherical sliding bearing 31 is composed of an inner ring 91, and an outer ring 92 whose inner surface (a portion constituting part of the spherical surface) slidably fits an outer surface of the inner ring 91 (a portion constituting part of the spherical surface). The reference symbols 93, 93 indicate stopper rings that anchor the inner ring 91 to the rotation shaft 27.

The stopper mechanism 85 is composed of two annular plates 95, 95 that are situated on either side of the outer ring 92 and main body part 86 when the outer ring 92 is fitted into a hole part 86a formed on the main body part 86, and a plurality of rivets 96 that anchor the annular plates 95, 95 to the main body part 86. The reference symbols 97, 97 indicate bolts for mounting the extending member 34 to the main body part 86.

The second holding device 33 is composed of a hydraulic motor 101 mounted to the main body part 86; a rotation shaft 104 mounted to an output shaft 102 of the hydraulic motor 101 by stopper screws 103, 103; and the holding piece 47 mounted to a distal end of the rotation shaft 104. The reference symbols 107, 107 (only one reference symbol 107 is shown) indicate holding members in which a hydraulic tube 108 connected to the hydraulic motor 101 rotatably holds the rotation shaft 104.

The rotation shaft 27, which is the shaft on which the first floating mechanism 28 and the second floating mechanism 32 float; the first lock mechanism 56 that locks the floating (swinging) of the first floating mechanism 28 relative to the platform 25; and the second lock mechanism 57 that locks the floating of the second floating mechanism 32 relative to the first floating mechanism 28 are shown in FIG. 4.

The first lock member 64 of the first lock mechanism 56 has a V-shaped cutout 64a. The first lock pin 62 engages with the cutout 64a and locks the first floating mechanism 28. The second lock member 73 of the second lock mechanism 57 has a V-shaped cutout 73a. The second lock pin 71 engages with the cutout 73a and locks the second floating mechanism 32.

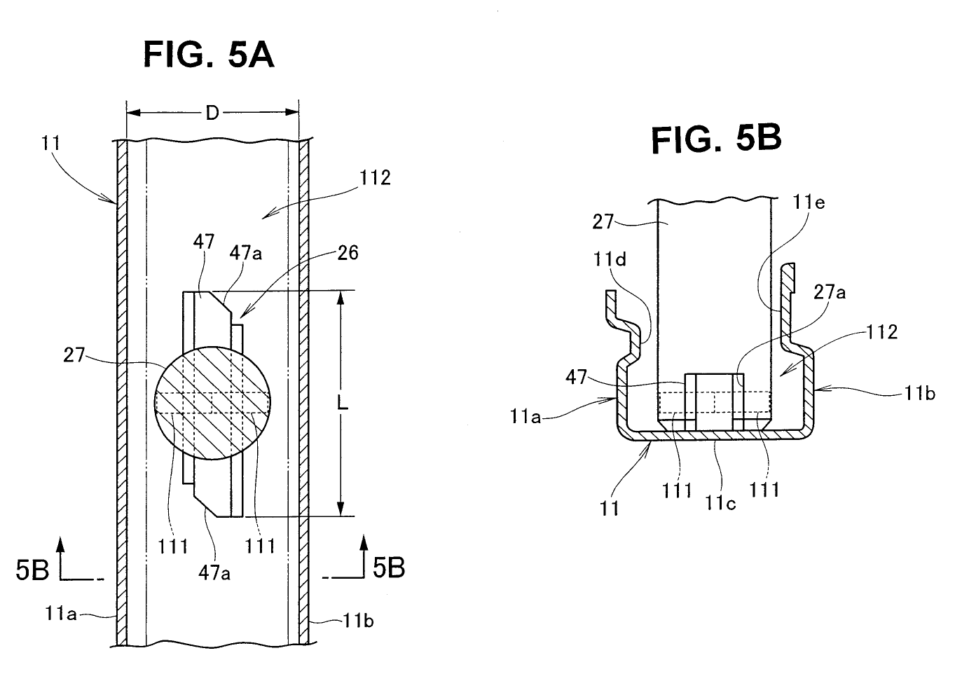

FIGS. 5A and 5B show the first holding device 26 shown in FIG. 3. The lower sash 11 is shown by the solid line and the double-dot dash line.

In FIG. 5A, the holding piece 47 of the first holding device 26 is mounted to the rotation shaft 27 by stopper screws 111, 111. The holding piece 47 is stopped at a position substantially parallel with side walls 11a, 11b of the lower sash 11 when not holding the lower sash 11.

L is greater than D, where L is the overall length of the holding piece 47, and D is the distance between the side walls 11a, 11b. The reference symbols 47a, 47a indicate inclined parts provided to end parts of the holding piece 47. These inclined parts come into contact with the side walls 11a, 11b when a hold is maintained.

In FIG. 5B, the holding piece 47 fits the recessed part 27a provided to the distal end of the rotation shaft 27, and is anchored to the rotation shaft 27 by the two stopper screws 111, 111 that pass through the holding piece 47.

The lower sash 11 has a recessed groove 112 that is U-shaped in cross section and is composed of the side walls 11a, 11b and a bottom wall 11c, which is in contact with the rotation shaft 27 or holding piece 47. When a rubber run channel that slides with the door glass is fitted inside, protruding parts 11d, 11e that are stoppers for the run channel are formed on the side walls 11a, 11b, respectively.

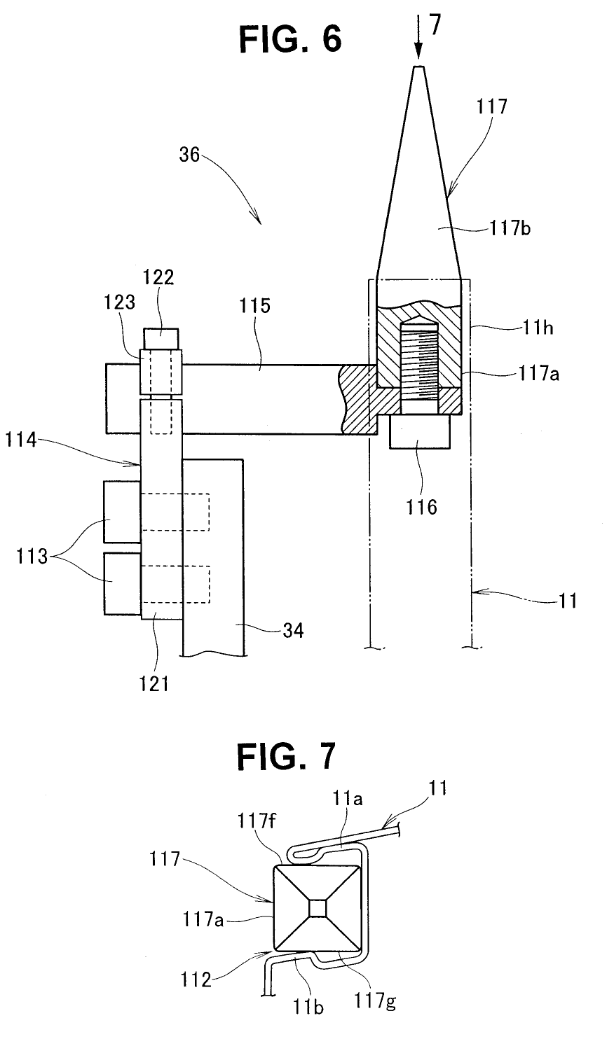

The fitting/positioning member 36 is composed of a support member 114 mounted to the extending member 34 by bolts 113, 113; a cylindrical bar 115 supported by the support member 114; and a positioning piece 117 mounted to a distal end of the bar 115 by a bolt 116, as shown in FIG. 6.

The support member 114 is composed of a first member 121; and a second member 123 mounted to an end part of the first member 121 by two bolts 122, 122 (only one reference symbol 122 is shown) in order to sandwich the bar 115. When the bolts 122, 122 are loose, a mounting angle about an axial center of the bar 115 changes, and the orientation of the positioning piece 117 can thereby be changed.

The positioning piece 117 is composed of a cross-sectionally rectangular part 117a, and a tapered part 117b constituting part of a square pyramid. The cross-sectionally rectangular part 117a fits an end part 11h of the lower sash 11.

FIG. 7 shows a state in which a side face 117f of the cross-sectionally rectangular part 117a of the positioning piece 117 is in contact with the side wall 11a of the lower sash 11. A small gap is present between a side face 117g of the cross-sectionally rectangular part 117a and the side wall 11b of the lower sash 11.

The shape of the lower sash 11 shown in FIG. 7 is different from the shape of the lower sash 11 shown in FIG. 5B. This is because the shapes of parts of the lower sash 11 gradually change in the length direction.

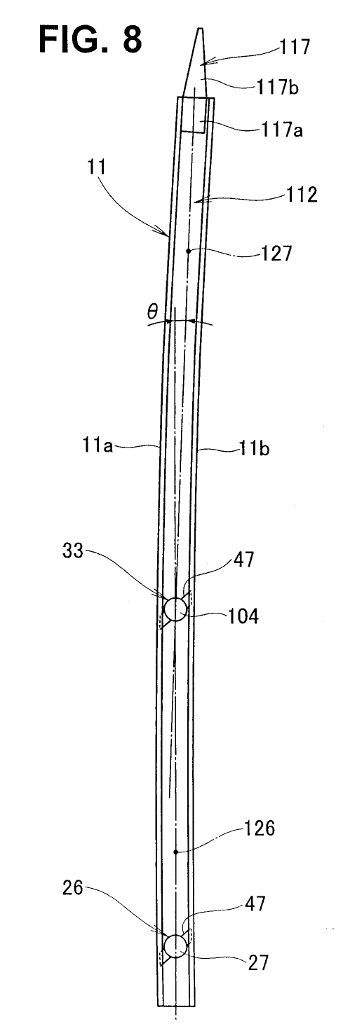

The lower sash 11 is formed into a curved shape in order to guide door glass formed into a curved shape, as shown in FIG. 8. For this reason, when taking a straight line 126 to be the straight line that connects axial centers of the rotation shaft 27 of the first holding device 26 and the rotation shaft 104 of the second holding device 33, and a straight line 127 to be the straight line connecting an axial center of the rotation shaft 104 and a center of the cross-sectionally rectangular part 117a of the positioning piece 117, then the straight line 126 and the straight line 127 are offset by angle θ.

In other words, in FIG. 2, the extending member 34 of the second floating mechanism 32 is mounted while inclined at angle θ toward the main body part 86. A structure is thus adopted in the second floating mechanism 32 in which the angle of the main body part 86 and the extending member 34 can be changed so as to correspond to lower sashes having different degrees of curvature.

Operations of the above-described first floating mechanism 28 and first lock mechanism 56, and the second floating mechanism 32 and second lock mechanism 57 shall be described next.

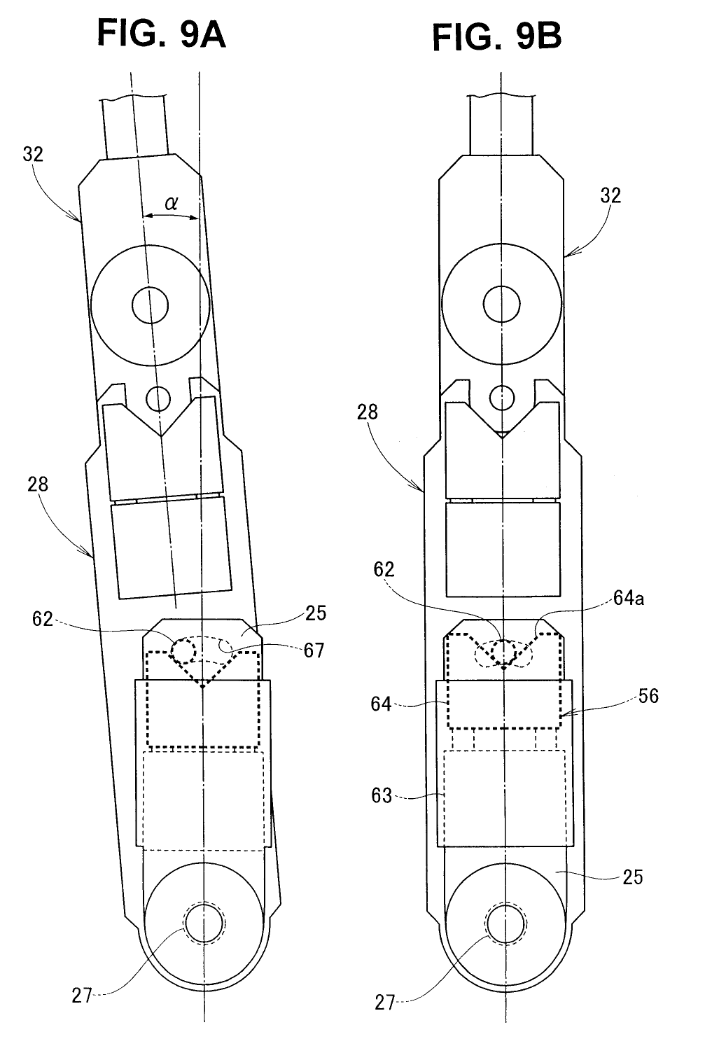

FIGS. 9A and 9B show operations of the first floating mechanism 28 and the first lock mechanism 56.

FIG. 9A shows a state in which the first floating mechanism 28 is made to float, i.e., swing, relative to the platform 25 by an angle α about the rotation shaft 27. The first lock pin 62 is in a state of contact with the end part of the arched elongated hole 67, and the angle α is the maximum swinging angle of the first floating mechanism 28.

In FIG. 9B, the first lock mechanism 56 is operated. In other words, hydraulic pressure is supplied to the first cylinder part 63; the first lock member 64 is advanced; i.e., is moved upward in the drawing; the cutout 64a of the first lock member 64 is engaged with the first lock pin 62; the first lock pin 62 is moved to the center of the V-shaped cutout 64a; the first floating mechanism 28 is moved to a predetermined location relative to the platform 25; and the first floating mechanism 28 is locked, i.e., is prevented from floating.

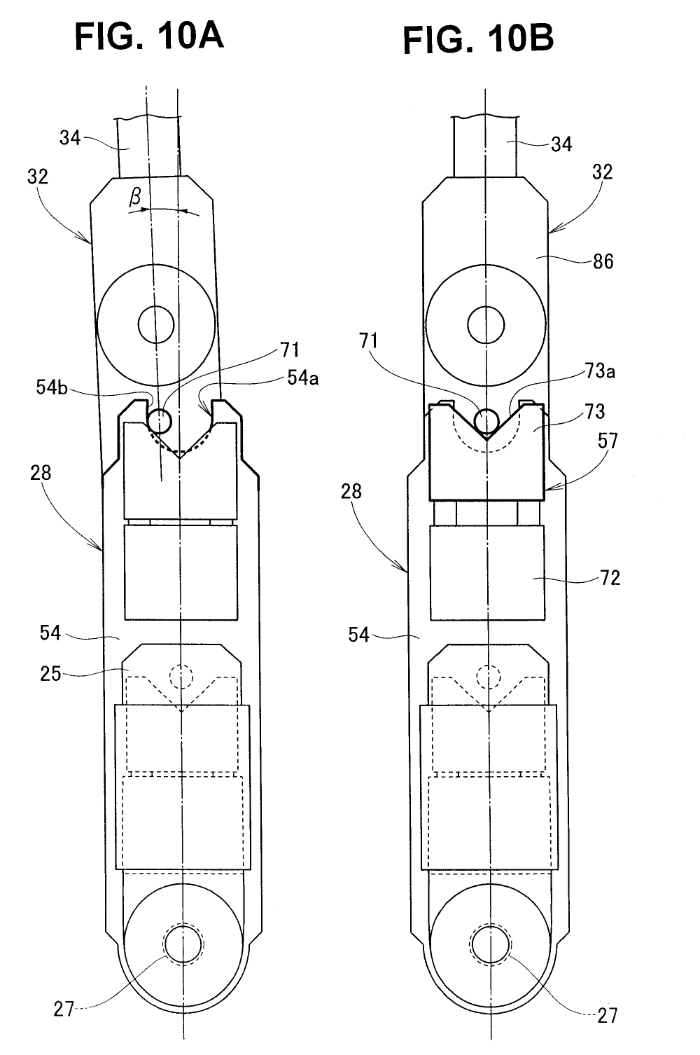

FIGS. 10A and 10B show operations of the second floating mechanism 32 and the second lock mechanism 57.

FIG. 10A shows a state in which the second floating mechanism 32 is made to float; i.e., swing, relative to the first floating mechanism 28, and specifically relative to the main body part 54, by an angle β about the rotation shaft 27. The second lock pin 71 is in a state of being in contact with an inner surface 54b of a U-shaped cutout part 54a provided to an end part of the main body part 54. The angle β is a maximum angle at which the second floating mechanism 32 swings relative to the first floating mechanism 28.

The second floating mechanism 32 can also float in the direction perpendicular to the page space relative to the platform 25 and the first floating mechanism 28 with the spherical sliding bearing 31 (see FIG. 3) acting as a fulcrum.

In FIG. 10B, the second lock mechanism 57 is operated. In other words, hydraulic pressure is supplied to the second cylinder part 72; the second lock member 73 is advanced, i.e., is moved upward in the drawing; the cutout 73a of the second lock member 73 engages with the second lock pin 71; the second lock pin 71 is moved to the center of the V-shaped cutout 73a; the second floating mechanism 32 is moved to a predetermined position relative to the main body part 54; and the second floating mechanism 32 is locked, i.e., is prevented from floating.

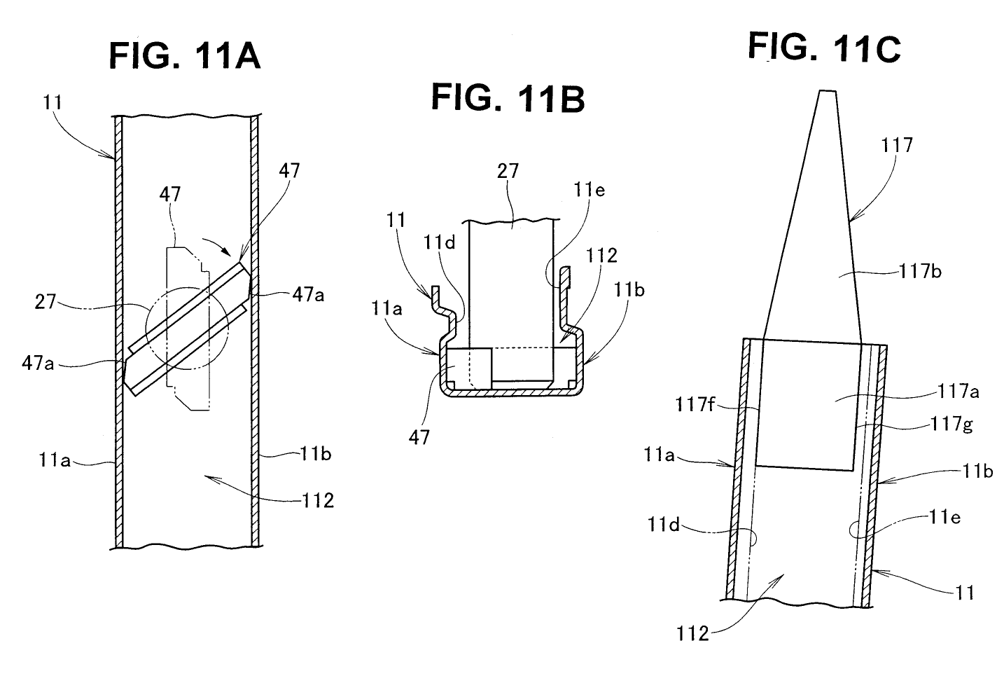

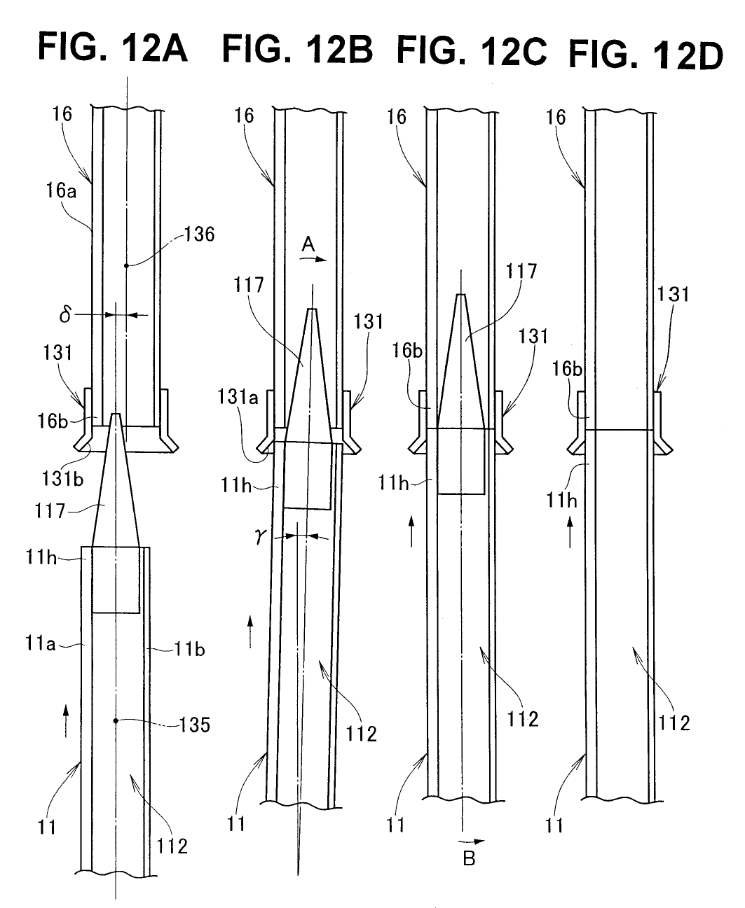

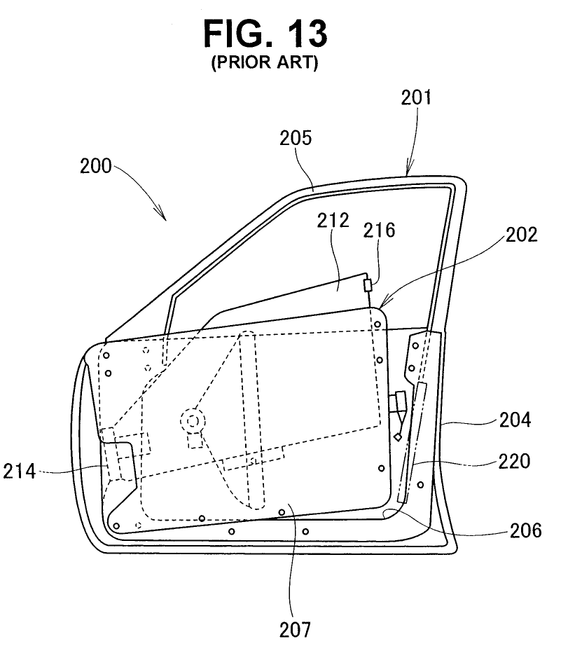

A procedure for positioning the lower sash 11 shall be described next with reference to FIGS. 11A through 11C and FIGS. 12A through 12D.

FIGS. 11A through 11C show a procedure for positioning the lower sash 11.

In FIG. 11A, the hydraulic motor 44 (not shown) of the first holding device 26 is operated; the rotation shaft 27 is rotated in a direction indicated by the arrow; the inclined parts 47a, 47a of the holding piece 47 are pressed against the side walls 11a, 11b of the lower sash 11, respectively; and the lower sash 11 is held.

FIG. 11B shows a state in which the lower sash 11 shown in FIG. 11A is being held. The lower sash 11 in the held state will fall away from the holding piece 47 because the protruding parts 11d, 11e are formed on the lower sash 11. The lower sash 11 is held by the second holding device 33 (see FIG. 3) in the same manner as shown in FIGS. 11A and 11B.

FIG. 11C shows a state in which the side surface 117f of the positioning piece 117 is in contact with the side wall 11a of the lower sash 11, and specifically the protruding part 11d.

In FIG. 12A, the positioning piece 117 of the lower sash 11 in the held state is brought near to a connecting piece 131 provided to a lower end part of the rear edge part 16a of the upper sash 16. The first floating mechanism 28 (see FIG. 9B) and the second floating mechanism 32 (see FIG. 10B) are in a state of being prevented from floating.

In FIG. 12B, the lock on the floating of the first floating mechanism 28 and the second floating mechanism 32 is released (i.e., the mechanisms switch to a floating state), and the positioning piece 117 is inserted into the upper sash 16. When a difference (δ indicates the amount of difference) is present between a central line 135 of the lower sash 11 and a central line 136 of the upper sash 16, the lower sash 11 and positioning piece 117 are tilted by an angle γ as indicated by the arrow A by the floating of the first floating mechanism 28 and the second floating mechanism 32, as shown in FIG. 12A. The end part 11h of the lower sash 11 is in a state of being in contact with a female tapered part 131a of the connecting part 131.

When the lower sash 11 and positioning piece 117 are moved further toward the upper sash 16, the end part 11h of the lower sash 11 fits in the connecting piece 131, as shown in FIG. 12C. When the floating of the first floating mechanism 28 and second floating mechanism 32 is locked, a high-magnitude reactive force is enacted upon the lower sash 11. Therefore, the conveying device swings the lower sash 11 as indicated by the arrow B and the positioning device positions the end part 11h of the lower sash 11 so as to connect with the end part 16b of the upper sash 16 in accordance with a signal from the force sensor that has detected the reactive force. The other end part of the lower sash 11 is anchored to the inner panel of the vehicle door by a bolt while in this state.

FIG. 12D shows a state in which the positioning device 12 (see FIG. 1) has been retracted from the state shown in FIG. 12C and the positioning piece 117 has been removed.

As shown in FIGS. 3, 5A, 5B, and 11A through 11C, the present invention is the holding device for a sash member composed of the first holding device 26 and the second holding device 33 that hold the lower sash (sash member) 11 having the cross-sectionally recessed groove 112. The holding device for a sash member comprises the holding piece (rotating pressing means) 47 of overall length L, which is greater than the width D of the groove 112 of the lower sash 11, that can be rotated by the hydraulic motors (drive sources) 44, 101 to press against the inner surfaces of the side walls 11a, 11b of the lower sash 11; and the positioning piece (sash positioning member) 117 that is provided to the hydraulic motors 44, 101, that is positioned in the groove 112 when the holding member 47 presses against the side walls 11a, 11b, that can come into contact with at least one side wall 11a, and specifically, the protruding part 11d (or the side wall 11b), and that can position the lower sash 11 relative to the upper sash (other sash member) 16.

Even when the width D of the cross-sectionally recessed groove 112 differs in the lower sash 11, the lower sash 11 can be held in accordance with the distance between the side walls 11a, 11b of the lower sash 11 to be held by the holding piece 47. The first holding device 26 and the second holding device 33 are highly versatile, and a holding device does not need to be prepared for each sash member with different distances between the side walls of the groove. In addition, the first holding device 26 and the second holding device 33 are composed of the holding piece 47 and the positioning piece 47. Therefore, the structure of the first holding device 26 and second holding device 33 can be made simpler. The cost of the first holding device 26 and second holding device 33 can accordingly be minimized.

The lower sash 11 can be rapidly held merely by having the hydraulic motors 44, 101 rotate the holding piece 47, thereby improving productivity when the vehicle door 10 (see FIG. 1) is manufactured. Also provided is the positioning piece 117, which can make contact with at least one of the side walls 11a (or side wall 11b). Therefore, the held lower sash 11 can be supported by the positioning piece 117, and stably supported while being held through to being mounted in the vehicle door 10.

In the present embodiment, the rotation shaft 27 and holding piece 47 of the first holding device 26 are provided separately, and the holding piece 47 is mounted on the rotation shaft 27 by the stopper screw 111, as shown in FIGS. 5A and 5B. However, this configuration is not provided by way of limitation. The holding piece 47 may be coupled with the rotation shaft 27 by welding or another method, or the holding piece may be integrated with the rotation shaft.

As described in FIGS. 1 through 3, the present invention is also the holding and positioning device 12 for a sash member for mounting on the vehicle door 10 in a state in which the lower sash (second sash member) 11 is connected to the upper sash (first sash member) 16 mounted to the vehicle door (target mounting member) 10. The holding and positioning device comprises the platform 25 mounted to the conveying device (conveying means) 21; the first holding device 26 mounted to the platform 25 in order to hold the lower sash 11; the second floating mechanism 32 mounted to an intermediate part of the first holding device 26 so as to be able to float and to be able to return to an original position; the second holding device mounted to the second floating mechanism 32; and the fitting/positioning member 36 provided to the second floating mechanism 32 so as to be able to fit the connecting piece (connecting part) 131 (see FIG. 12C) provided to the upper sash 16 in order to position, in relation to the end part 16b of the upper sash 16, the end part 11h (see FIG. 12C) of the lower sash 11 held by the first holding device 26 and second holding device 33.

Therefore, the lower sash 11 held by the first holding device 26 and second holding device 33 can be allowed to float using an uncomplicated structure, and the lower sash harbor 11 is made to float using the second floating mechanism 32, whereby the lower sash 11 can be readily positioned in relation to the upper sash 16 using the positioning piece 117 of the fitting/positioning member 36, while any errors associated with contact of the upper sash 16 against the vehicle door 10 is eliminated.

In the present embodiment, the first floating mechanism 28 and second floating mechanism 32 are configured to float simultaneously. However, this arrangement is not provided by way of limitation. A configuration may also be adopted in which the second floating mechanism 32 is always in a locked state and only the first floating mechanism 28 is allowed to float, as shown in FIGS. 12A through 12D.

### INDUSTRIAL APPLICABILITY

The gripping (holding) device and position device for a sash member of the present invention can be used to mount a lower sash to a vehicle door

1. A holding device for holding a sash member of U-shaped cross section with a groove, the holding device comprising:
a rotating pressing means having an overall length longer than a width of the groove and being designed to be rotated by a drive source to press against inner surfaces of first and second side walls of the sash member upon rotation thereof, and
a sash positioning member which is positioned in the groove upon pressing of the rotation pressing means against the inner surfaces of the first and second side walls, and which comes into contact with at least one of the first and second side walls for positioning the sash member relative to a companion sash member.

2. The holding device of claim 1, wherein the rotating pressing means has inclined parts provided on longitudinally opposite ends thereof for contact with the inner surfaces of the first and second side walls of the sash member.

3. A holding/positioning device for holding and positioning, relative to a first sash member mounted to an associated member, a second sash member in a held state, the holding/positioning device comprising:
a platform for mounting to a conveying means;
a first holding means mounted to the platform for holding the second sash member;
a floating mechanism mounted to an intermediate part of the first holding means in such a manner as to be capable of floating and returning to an original position thereof;
a second holding means mounted to the floating mechanism for holding the second sash member; and
a fitting/positioning means provided to the floating mechanism in such a manner as to be insertable into a connecting part provided to the first sash member, so that an end of the second sash member held by the first and second holding means is positioned relative to a corresponding end of the first sash.
